(19) United States
(12) Patent Application Publication
(10) Pub. No.: US 2026/0061517 A1
(43) Pub. Date: Mar. 5, 2026

(54) EXTRACTION AND FILTRATION OF POLLUTED AIR IN A LASER PRINTING SYSTEM FOR MICROSCOPE SLIDES

(71) Applicant: SHANDON DIAGNOSTICS LIMITED, Runcorn (GB)

(72) Inventors: Michael Thomas Adams, Liverpool (GB); Molly Harris, Liverpool (GB); Basil Constantine Gaynor, Holmes Chapel (GB); Blai Saleta, Jackson, NH (US)

(21) Appl. No.: 18/817,953

(22) Filed: Aug. 28, 2024

(51) Int. Cl. B23K 26/142; B01D 29/085; B23K 26/352; B23K 26/70; G02B 21/34

(52) U.S. Cl. CPC B23K 26/142; B01D 29/085; B23K 26/352; B23K 26/702; B01D 2267/40; G02B 21/34

(57) ABSTRACT

Systems, methods, and devices for providing an extraction and filtration technique for polluted air output from a laser printing system. The extraction and filtration technique including a plenum proximate to a printing or marking area of the laser printing system for receiving emissions output from the laser printing system and containing polluted air comprising the emissions to reduce a volume of polluted air, one or more filters for filtering emissions from the polluted air, and a fan assembly in fluid communication with the plenum extracting the polluted air to flow a stream of the polluted air from the plenum and through the one or more filters to filter at least a portion of the particulate matter and volatile organic compounds from the polluted air to produce filtered air.

### BACKGROUND

### 1. Field

Embodiments of the present disclosure generally relate to systems and methods for extracting and filtering polluted air. More specifically, embodiments of the present disclosure relate to systems and methods for extracting and filtering polluted air comprising particulate matter, airborne molecular contamination, and/or volatile organic compounds from laser printing systems for microscope slides.

### 2. Related Art

Laser printing systems utilize a laser to mark objects, such as microscope slides. While marking microscope slides, laser printing systems produce emissions such as particulate matter and volatile organic compounds (VOCS) that are discharged into the environment and within the laser printing system that cause odor, user discomfort, and health risks in certain concentrations. Previous techniques for extracting and filtering emissions include flowing air from front vents of the laser printing system, through the laser printing system, and through an axial fan and filter comprising an M5 synthetic filter and carbon filter at the back of the laser printing system. These techniques include axial fans to draw air away from the source of emissions, over/through internal mechanisms of the laser printing system, and toward the filter. These previous techniques for extracting and filtering allow for particulate matter to accumulate at a plurality of areas between the source of the emissions and the filter. For example, the polluted air may be flowed proximate the internal mechanisms of laser printing system, such as one or more electronic areas, that accumulate particulate matter from the source of emissions over time. Such an accumulation of particulate matter may impact the functionality and/or the lifespan of the internal mechanisms (e.g., mechanical and/or electrical components) of the laser printing system. For example, an accumulation of particulate matter may impede the movement of moving mechanical components (e.g., lead screws that drive the laser printing system) and decrease the lifespan and functionality of electrical components (e.g., optical sensors). Previous techniques for extracting and filtering polluted air do not prevent the accumulation of particulate matter on the internal mechanisms of the laser printing system.

### SUMMARY

Embodiments of the present disclosure solve the above-mentioned problems by providing systems, devices, and methods for extracting and filtering polluted air comprising emissions output from a laser printing system. Embodiments of the present disclosure include a plenum for receiving the emissions output from the laser printing system, a fan assembly for extracting the polluted air comprising the emissions, and at least one filter for filtering the polluted air. The plenum may be located proximate a printing or marking area of the laser printing system and contain a volume of polluted air such that the polluted air may be directed away from one or more components of the laser printing system to prevent or reduce the accumulation of emissions from the laser printing system on the one or more components. Further, the plenum may prevent or reduce the escape of emissions from the laser printing system, such that the volume of polluted air created is reduced. The fan assembly may prevent or reduce the accumulation or the pollutants by flowing the polluted air directly from the source of emissions and through one or more filters.

Clause 1. A system for mounting in a laser printing system and for extracting and filtering polluted air output during a laser printing process for marking microscope slides, the system comprising: a plenum comprising a chamber for receipt of the polluted air output from the laser printing system; a pre-filter in fluid communication with the plenum, wherein the pre-filter receives a stream of air therethrough comprising the polluted air contained in the plenum, wherein a flow of the stream of air through the pre-filter filters out particulate matter having a coarse size to produce a pre-filtered stream of air; one or more filters in fluid communication with the pre-filter, wherein the one or more filters receive the pre-filtered stream of air from the pre-filter, wherein the one or more filters comprises: a first filter to filter at least a portion of the particulate matter having a first size, wherein the first size of the particulate matter is less than the coarse size of the particulate matter filtered by the pre-filter; and a second filter to filter at least a portion of volatile organic compounds; and a fan assembly comprising at least a fan for providing a pressure differential to the system to cause flow of the stream of air from the plenum, through the pre-filter, through the fan assembly, and through the one or more filters.

Clause 2. The system of clause 1, wherein the plenum comprises one or more members defining a holding area, wherein the pre-filter is at least partially disposed within the holding area.

Clause 3. The system of any of clauses 1 or 2, wherein the plenum further comprises one or more support holders removably couplable to the laser printing system.

Clause 4. The system of any of clauses 1 through 3, wherein the fan assembly is disposed downstream from the pre-filter and disposed upstream from the one or more filters, wherein the one or more filters further comprises a third filter to filter at least a portion of the particulate matter having a second size, wherein the second size of the particulate matter is less than the first size of the particulate matter filtered by the first filter, wherein the third filter is disposed downstream from the first filter and disposed upstream from the second filter.

Clause 5. The system of any of clauses 1 through 4, further comprising: a multistage filtration cartridge comprising the one or more filters; and a funnel in fluid communication with the pre-filter and the multistage filtration cartridge, wherein the funnel receives the pre-filtered stream of air therethrough, wherein the multistage filtration cartridge receives the pre-filtered stream of air from the funnel, wherein the multistage filtration cartridge is in fluid downstream communication with the funnel, such that the pre-filtered stream of air outputted from the funnel is input to the multistage filtration cartridge to expand a cross-sectional area of the pre-filtered stream of air prior to inputting the pre-filtered stream of air to the multistage filtration cartridge.

Clause 6. The system of any of clauses 1 through 5, wherein the plenum further comprises an opening for receiving a laser of the laser printing system, wherein the laser extends through the chamber of the plenum and towards a printing area of the laser printing system.

Clause 7. The system of any of clauses 1 through 6, wherein the plenum further comprises: a first cross-sectional area; a second cross-sectional area that is greater than the first cross-sectional area; and one or more extending surfaces that transitions the first cross-sectional area of the plenum to the second cross-sectional area of the plenum.

Clause 8. The system of any of clauses 1 through 7, wherein the fan assembly comprises a bladeless fan.

Clause 9. The system of any of clauses 1 through 8, wherein the fan assembly is disposed downstream from the plenum and the multistage filtration cartridge.

Clause 10. The system of any of clauses 1 through 9, further comprising a suction adaptor that fluidly couples the plenum to the fan assembly.

Clause 11. A system for mounting in a laser printing system and for extracting and filtering polluted air output during a laser printing process for marking microscope slides, the system comprising: a plenum comprising a chamber for receipt of the polluted air output from the laser printing system; one or more filters in fluid communication with the plenum, wherein the one or more filters receives a stream of air therethrough comprising the polluted air contained in the plenum, wherein the one or more filters filter at least a portion of particulate matter and at least a portion of volatile organic compounds; and a fan assembly for providing a pressure differential to the system to cause flow of the stream of air from the plenum and through the one or more filters.

Clause 12. The system of clause 11, wherein the fan assembly comprises a bladeless fan.

Clause 13. The system of any of clauses 11 or 12, wherein the plenum comprises an opening for receiving a laser from the laser printing system such that the laser extends through the chamber of the plenum and marks one or more microscope slides in a marking area of the laser printing system.

Clause 14. The system of any of clauses 11 through 13, wherein the one or more filters comprises a first filter for filtering at least a portion of the particulate matter having a first size, wherein the one or more filters further comprises a second filter for filtering at least a portion of the particulate matter having a second size, wherein the second size of the particulate matter is less than the first size of the particulate matter filtered by the first filter, wherein the one or more filters further comprises a third filter for filtering at least a portion of the volatile organic compounds, wherein the third filter is disposed downstream from the first filter and the second filter.

Clause 15. The system of any of clauses 11 through 14, further comprising: a multistage filtration cartridge comprising the one or more filters, wherein the fan assembly is disposed downstream from the plenum and disposed upstream from the multistage filtration cartridge.

Clause 16. The system of any of clauses 11 through 15, further comprising: a multistage filtration cartridge comprising the one or more filters, wherein the fan assembly is disposed downstream from the plenum and the multistage filtration cartridge.

Clause 17. The system of any of clauses 11 through 16, further comprising a suction adaptor that fluidly couples the plenum to the fan assembly.

Clause 18. The system of any of clauses 11 through 17, further comprising: a funnel disposed upstream from at least one of the one or more filters, wherein the funnel receives the stream of air and expands a cross-sectional area of the stream of air prior to inputting the stream of air to at least one of the one or more filters.

Clause 19. A method for extracting and filtering emissions from a laser printing process for marking microscope slides via an extraction system, the method comprising: receiving emissions output from the laser printing process via a plenum of the extraction system; containing polluted air comprising the emissions in the plenum of the extraction system, wherein the extraction system further comprises a fan assembly and one or more filters; extracting, by flowing via the fan assembly, the polluted air from the plenum to form a stream of air comprising the polluted air; and flowing the stream of air through the one or more filters to filter at least a portion of particulate matter and at least a portion of volatile organic compounds to form a filtered stream of air.

Clause 20. The method of clause 19, wherein the extraction system further comprises a pre-filter, wherein the method further comprises flowing the polluted air through the pre-filter to filter at least a portion of the particulate matter having a coarse size prior to flowing the polluted air through the one or more filters.

Clause 21. The method of any of clauses 19 or 20, wherein the plenum comprises: a first cross-sectional area; a second cross-sectional area that is greater than the first cross-sectional area; and one or more extending surfaces that transitions the first cross-sectional area of the plenum to the second cross-sectional area of the plenum, wherein the method further comprises expanding a cross-sectional area of the stream of air via the one or more extending surfaces to distribute the stream of air across a surface of the pre-filter.

Clause 22. The method of any of clauses 19 through 21, wherein the extraction system further comprises a multistage filtration cartridge comprising a first filter stage having a first filter of the one or more filters, a second filter stage having a second filter of the one or more filters, and a third filter stage having a third filter of the one or more filters, wherein flowing the stream of air through the one or more filters comprises: flowing the stream of air through the first filter stage to filter at least a portion of the particulate matter having a first size; flowing the stream of air through the second filter stage to filter at least a portion of the particulate matter having a second size smaller than the first size; and flowing the stream of air through the third filter stage to filter at least a portion of the volatile organic compounds.

Clause 23. The method of any of clauses 19 through 22, further comprising: marking one or more microscope slides via a laser, wherein the laser extends through an opening of the plenum, wherein extracting the polluted air is in response to marking the one or more microscope slides.

Clause 24. The method of any of clauses 19 through 23, wherein the extraction system further comprises a funnel directly fluidly coupled to at least one of the one or more filters, wherein the method further comprises expanding a cross-sectional area of the stream of air via the funnel to distribute the stream of air across a surface of at least one of the one or more filters.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWINGS

Embodiments of the present disclosure are described in detail below with reference to the attached drawing figures, wherein:

FIG. 1 depicts a front isometric view of an exemplary system for extracting and filtering polluted air according to some embodiments;

FIG. 2 depicts a back isometric view of an exemplary system for extracting and filtering polluted air according to some embodiments;

FIG. 3 depicts a top cross-sectional view of an exemplary system for extracting and filtering polluted air according to some embodiments;

FIG. 4 depicts an exemplary plenum according to some embodiments;

FIG. 5 depicts an exemplary laser printing system with an extraction system according to some embodiments; and

FIG. 6 depicts an exemplary method for extracting and filtering polluted air.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description of embodiments of the present disclosure references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of embodiments of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

As used herein, emissions may refer to any combination of particulate matter (PM), airborne molecular contamination (AMC), volatile organic compounds (VOCS), ozone, or odors produced as a by-product of a system, such as a laser printing system for use in printing on microscope slides. As used herein, polluted air may refer to air comprising emissions (e.g., particulate matter, AMC, and/or VOCS), such as emissions created from the laser printing process. As used herein, PM may refer to any of solid particles, liquid droplets, and/or particle pollution found in the air. The size of PM may be measured using the diameter of the PM in micrometers (μm). For example, PM₁₀ refers to PM with a diameter of 10 μm or less and PM_{2.5} refers to PM with a diameter of 2.5 μm or less. As used herein, coarse particles may refer to PM with a diameter of 10 μm to 2.5 μm, fine particles may refer to PM with a diameter of 2.5 μm to 0.1 μm, and ultrafine particles may refer to PM with a diameter of less than 0.1 μm.

As used herein, AMC may refer to highly diluted particles within the air such as bases (e.g., NH₃, Amines, TMA, NMP, AsH₃, TMAH), acids (e.g., HF SOₓ, HCl, NOₓ, H₂S, HBr, BF₃, H₂SO₄), condensables (e.g., BHT, DOP, DBP, TMB, Siloxanes), and dopants (e.g., TEP, PH₃, BF₃, B₂H₆, AsH₃). As used herein, VOCS may refer to compounds having a high vapor pressure and low water solubility (e.g., benzene, toluene, xylene).

There exists a need for extraction and filtration systems that reduce or prevent the accumulation of emissions within a laser printing system, such as a laser printing system used for printing on microscope slides. Embodiments of the present disclosure provide systems, devices, and methods for extracting and filtering polluted air from a source of emissions. Embodiments of the present disclosure include a plenum proximate a printing or marking area of a laser printing system for receiving the emissions output from the laser printing system and a fan assembly for extracting the polluted air comprising the emissions from the plenum and flowing the polluted air through at least one filter to filter the polluted air. The plenum may be located proximate a printing or marking area of the laser printing system and contain a volume of polluted air such that the polluted air may be directed away from one or more components of the laser printing system to prevent or reduce the accumulation of emissions on the one or more components of the laser printing system. Further, the plenum may prevent or reduce the escape of emissions from the laser printing system, such that the volume of polluted air created is reduced. The fan assembly may prevent or reduce the accumulation of the pollutants by flowing the polluted air directly from the source of emissions and through one or more filters.

The plenum of the extraction system provides an improvement to the reduction of emissions created during a laser printing process. The plenum receives the emissions from the laser printing system such that the emissions output to the environment from the laser printing system are reduced or prevented. In some embodiments, the extraction systems described herein provide a ten times greater reduction in particulate matter being emitted into the environment when compared to previous techniques.

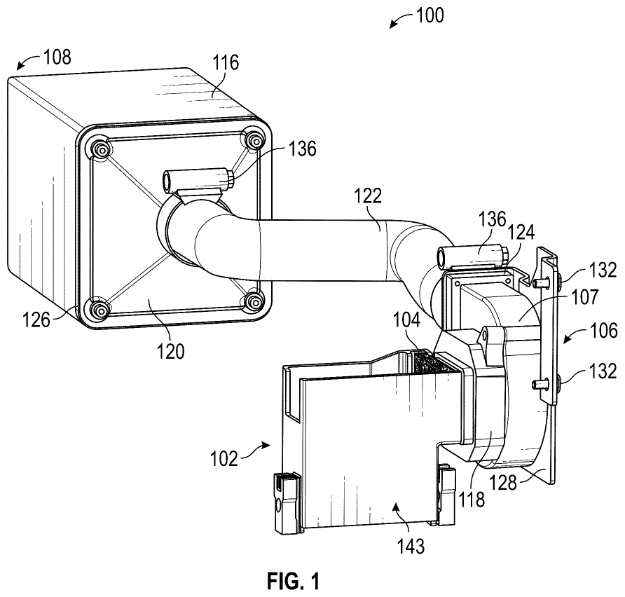

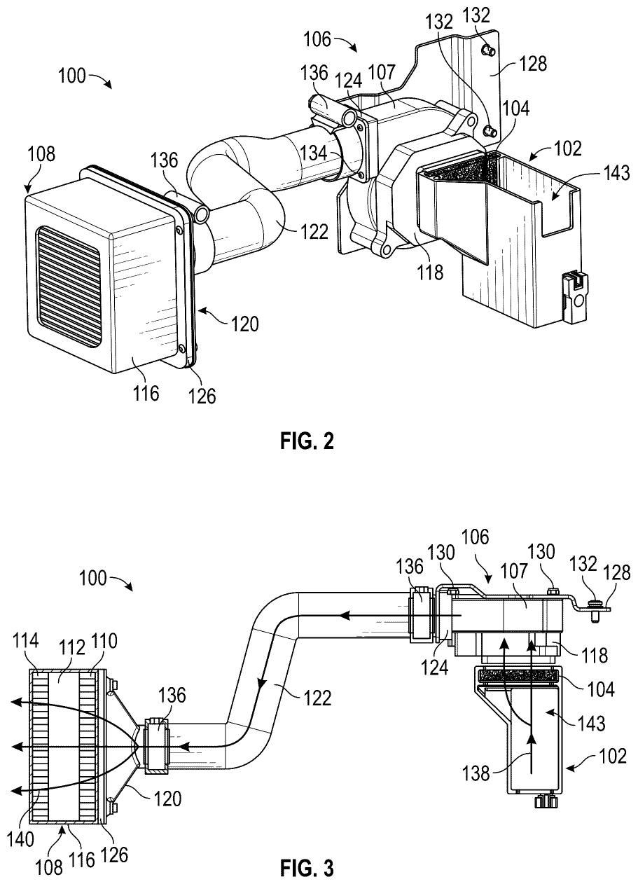

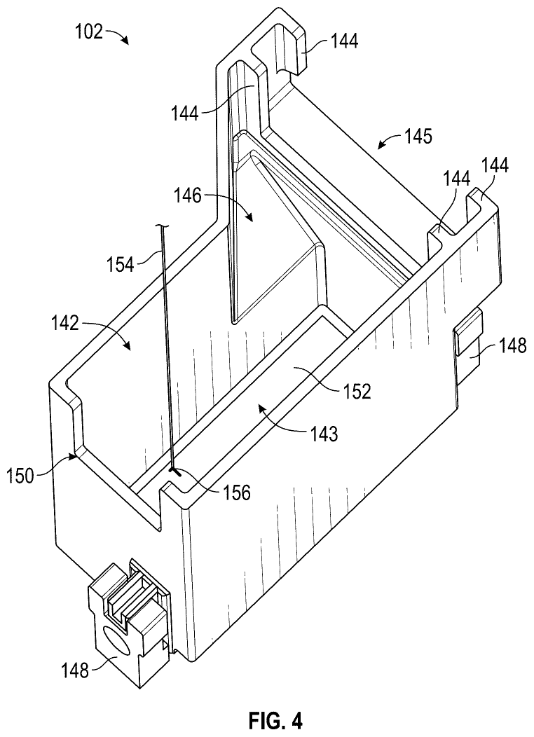

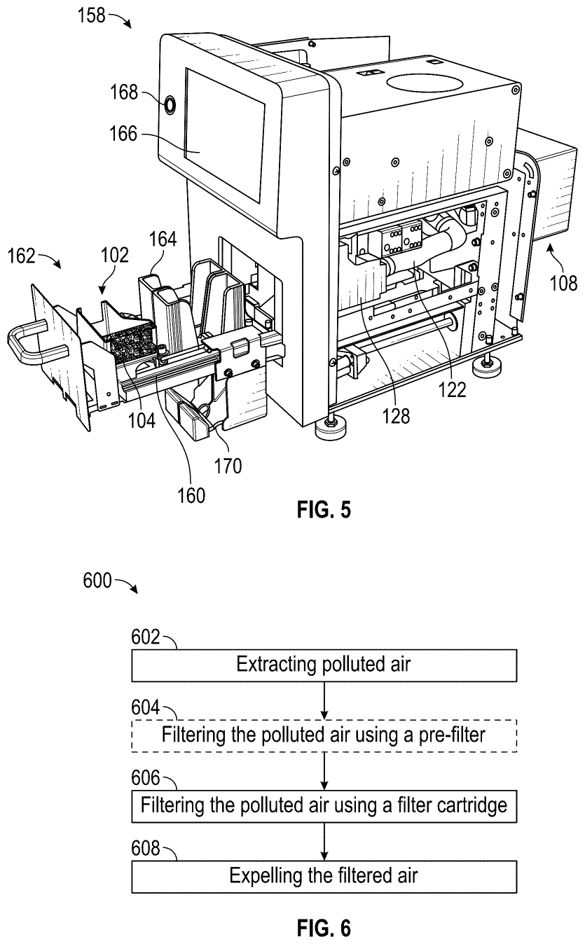

FIG. 1-2 depict isometric views of an exemplary extraction system 100 for extracting and filtering polluted air according to some embodiments. The extraction system is for use with a laser printing system, such as laser printing system 158 illustrated in FIG. 5. For example, extraction system 100 may be mounted within a laser printing system to extract and filter polluted air output during a laser printing process. In some embodiments, extraction system 100 comprises a plenum 102, a pre-filter 104, a fan assembly 106, and a multistage filtration cartridge 108. Plenum 102 may be configured to receive emissions output from the laser printing system. For example, plenum 102 may comprise a chamber 143 (described in more detail below in FIG. 4) proximate a marking or printing area of the laser printing system, such that output emissions enter into chamber 143. Forcing the output emissions into chamber 143 may reduce a volume of polluted air created by the source of emissions. Plenum 102 is described in further detail below in FIG. 4. Fan assembly 106 may provide a pressure differential and/or a flowrate that flows the polluted air from plenum 102 and through the filters of extraction system 100, such as pre-filter 104 and/or multistage filtration cartridge 108, to produce filtered air.

Plenum 102 is positioned in the laser printing system 158 to receive emissions output from the laser printing process, such as the VMs, PMs, AMCs, and VOCS discussed above. Plenum 102 comprises a housing forming a chamber for receipt of the output emissions from the laser printing process. The plenum is advantageously located in the laser printing system proximate a marking or printing area of the laser printing system, such that output emissions are captured into the chamber of the plenum. Fan assembly provides a static pressure and/or volumetric flowrate to extraction system 100 to flow the output emissions into chamber 143 of plenum 102, such that polluted air comprising the emissions is contained within plenum 102.

In embodiments, the plenum's housing includes an open side, such as open top shown in FIG. 1, that may mate with an enclosure (not shown) in the laser printing system when the plenum is positioned in the laser printing system for use. When positioned for use, the plenum in concert with the laser printing system's enclosure may contain the outputted emissions so that the emissions do not flow to other components within the laser printing system or external to the laser printing system. As such, the emissions are drawn into the chamber of the plenum via an open side of the plenum. As can be appreciated, the emissions are held in air that is contained in the plenum's volume.

Plenum 102 thus prevents emissions, such as particulate matter, from escaping the chamber 143 of plenum 102. For example, plenum 102 may be proximate to or surround a microscope slide receiving a laser printing process and receive the produced emissions from the laser printing process. The air comprising the emissions (i.e., polluted air) within plenum 102 may then be extracted and filtered by extraction system 100. In some embodiments, plenum 102 may be configured to hold pre-filter 104.

In some embodiments, pre-filter 104 may be a first filter configured to filter larger particulate matter, such as particular matter with a diameter of 10 μm or larger. By filtering out larger particulate matter (e.g., coarse particles or particulate matter with a diameter of 10 μm or larger), fan assembly 106 may be protected from larger particles that would otherwise diminish the life cycle of fan assembly 106. Additionally, filtering larger particles before flowing the polluted air through multistage filtration cartridge 108 may prevent multistage filtration cartridge 108 from becoming saturated with larger particles and allow multistage filtration cartridge 108 to catch smaller particles (e.g., particles with a diameter of 10 μm or less). As used herein, a filter being saturated refers to the state of a filter in which the airflow through the filter is reduced by 50%. In some embodiments, pre-filter 104 may filter at least 40%, at least 50%, at least 60%, at least 70%, or at least 80% of the particulate matter have a diameter of 10 μm or larger. In other words, pre-filter 104 may prevent at least 40%, at least 50%, at least 60%, at least 70%, or at least 80% of the particulate matter having a diameter of 10 μm or larger from reaching fan assembly 106 and/or multistage filtration cartridge 108.

In some embodiments, pre-filter 104 may have a cross-sectional area within a range of 0.25 square centimeters (cm²) to 100 cm², within a range of 1 cm² to 75 cm², within a range of 5 cm² to 50 cm², or within a range of 10 cm² to 25 cm² and a thickness within a range of 1 millimeter (mm) to 20 mm, within a range of 2.5 mm to 15 mm, or within a range of 5 mm to 10 mm. For example, pre-filter 104 may have a cross-sectional area of 15.75 cm² and a thickness of 7 mm. In some embodiments, pre-filter 104 may have a width within a range of 5 mm to 100 mm, within a range of 15 mm to 75 mm, or within a range of 25 mm to 50 mm, a height within a range of 5 mm to 100 mm, within a range of 15 mm to 75 mm, or within a range of 25 mm to 50 mm, and a thickness within a range of 1 mm to 20 mm, within a range of 2.5 mm to 15 mm, or within a range of 5 mm to 10 mm. For example, pre-filter 104 may have a width of 45 mm, a height of 35 mm, and a thickness of 7 mm.

Embodiments are contemplated in which pre-filter 104 may have any width, height, thickness, and/or cross-sectional area suitable for filtering polluted air and/or for coupling to plenum 102 and/or fan assembly 106. In some embodiments, the width, height, thickness, and/or cross-sectional area of pre-filter 104 may depend at least in part on the volume of polluted air configured to be extracted using extraction system 100. For example, if extraction system 100 is configured to extract a larger volume of polluted air, pre-filter 104 may have a larger width, height, thickness, and/or cross-sectional area suitable to filter the larger volume of polluted air.

Pre-filter 104 may comprise an edging, casing, and/or tab (e.g., similar to housing 116 of multistage filtration cartridge 108) to facilitate retaining emissions while removing pre-filter 104 from a laser printing system (e.g., laser printing system 158 described below) to clean or replace pre-filter 104. In some embodiments, pre-filter 104 is removably couplable to the laser printing system such that pre-filter 104 may be removed, cleaned, and recoupled to the laser printing system. Alternatively, or additionally, pre-filter 104 may be consumable such that when pre-filter 104 becomes saturated, pre-filter 104 is removed, disposed of, and replaced by a new pre-filter.

In some embodiments, multistage filtration cartridge 108 may comprise a plurality of filter stages configured to filter emissions, such as particulate matter with a diameter of 0.1 μm or larger and volatile organic compounds (VOCs). Further, multistage filtration cartridge 108 may comprise a first filter stage 110, a second filter stage 112, and a third filter stage 114 as described in more detail below in FIG. 3. In some embodiments, multistage filtration cartridge 108 may comprise a housing 116 configured to provide rigidity to the plurality of filter stages (e.g., first filter stage 110, second filter stage 112, and third filter stage 114) and/or the multistage filtration cartridge 108. In some embodiments, housing 116 couples the plurality of filter stages 110, 112, 114 together.

Fan assembly 106 may provide a static pressure and volumetric flowrate that is sufficient to flow the emissions output from a laser printing system to chamber 143 of plenum 102 and flow the polluted air comprising the emissions through extraction system 100 to form filtered air. Fan assembly 106 may produce a static pressure sufficient to penetrate filtration media (e.g., pre-filter 104 and/or multistage filtration cartridge 108) and reduce blowback, noise, and power requirements. As used herein, static pressure may be the pressure of a fluid on a body when the body is at relative rest to the fluid. For example, fan assembly 106 may provide a static pressure of 300 Pa, in other words, fan assembly 106 pressurizes the air such that the air exerts a pressure of 300 Pa on one or more interior walls of extraction system 100. In some embodiments, one or more components of extraction system 100 may have an airflow resistance that resists the flow of air through extraction system 100. For example, one or more filters (e.g., pre-filter 104 and/or multistage filtration cartridge 108) may have an airflow resistance up to 20 Pascals (Pa).

In some embodiments, the total airflow resistance of extraction system 100 may be up to 20 Pa, up to 50 Pa, up to 100 Pa, up to 150 Pa, up to 200 Pa, up to 250 Pa, up to 300 Pa, or greater than 300 Pa. Fan assembly 106 may provide a static pressure of greater than 20 Pa, greater than 50 Pa, greater than 100 Pa, greater than 150 Pa, greater than 200 Pa, greater than 250 Pa, or greater than 300 Pa such that the static pressure is greater than the total airflow resistance of extraction system 100. For example, fan assembly 106 may provide a static pressure of up to 50 Pa, within a range of 50 Pa to 100 Pa, within a range of 100 Pa to 400 Pa, within a range of 100 Pa to 300 Pa, within a range of 100 Pa to 200 Pa, within a range of 200 Pa to 300 Pa, or greater than 300 Pa.

In some embodiments, fan assembly 106 provides an efficient volumetric flowrate to flow the polluted air through extraction system 100. For example, fan assembly 106 may provide a volumetric flowrate within a range of 0.1 cubic meters per minute (m³/min) to 0.75 m³/min, within a range of 0.15 m³/min to 0.6 m³/min, within a range of 0.2 m³/min to 0.5 m³/min, within a range of 0.25 m³/min to 0.4 m³/min, or within a range of 0.3 m³/min to 0.35 m³/min. For example, fan assembly 106 may provide a volumetric flowrate within a range of 0.33 m³/min to 0.34 m³/min. Embodiments are contemplated in which fan assembly 106 provides a volumetric flowrate of greater than 0.25 m³/min, greater than 0.5 m³/min, greater than 0.75 m³/min, or greater than 1 m³/min. Embodiments are also contemplated in which fan assembly 106 provides a volumetric flowrate of less than 0.25 m³/min, less than 0.1 m³/min, or less than 0.05 m³/min, as long as the volumetric flowrate is sufficient to flow polluted air through extraction system 100.

As depicted in FIGS. 1-3, fan assembly 106 may comprise a fan 107 to provide the static pressure and volumetric flowrate as described above. Embodiments are contemplated in which fan assembly 106 may comprise any combination of fans, such as axial fans and/or centrifugal fans, and/or compressors, such as positive displacement compressors and/or dynamic compressors, configured to provide a pressure differential to extract the polluted air. For example, fan assembly 106 may comprise any combination of a centrifugal fan, an axial fan, a blower fan, or any other suitable fan and/or compressor. In some embodiments, system 100 may utilize one or more fan assemblies 106. For example, system 100 may utilize a plurality of fan assemblies in parallel and/or in series with one another. Embodiments are contemplated in which a compressor assembly may be used rather than fan assembly 106. In such embodiments, the compressor assembly may comprise one or more compressors configured to provide a pressure differential to extract the polluted air.

In some embodiments, the static pressure and/or the volumetric flowrate provided by fan assembly 106 may depend at least in part on the volume of polluted air configured to be extracted by extraction system 100. For example, if extraction system 100 is configured to extract a larger volume of polluted air, fan assembly 106 may provide a larger static pressure and/or volumetric flowrate suitable to extract the larger volume of polluted air.

In some embodiments, extraction system 100 further comprises a suction adaptor 118 configured to facilitate the fluid coupling of plenum 102 and/or pre-filter 104 to fan assembly 106. In some embodiments, suction adaptor 118 may reduce or prevent leakage of air between plenum 102 and fan assembly 106. Suction adaptor 118 may be configured to provide an airtight connection of plenum 102 and fan assembly 106. Suction adaptor 118 may couple to plenum 102 such that the polluted air may flow from the plenum to fan assembly 106. In some embodiments, suction adaptor 118 may include one or more fasteners to facilitate the fluid coupling of plenum 102 and fan assembly 106. For example, suction adaptor 118 may comprise one or more snap fit fasteners or other suitable fasteners.

In some embodiments, any fluid communication and/or coupling of components within extraction system 100 may be airtight such that polluted air does not leak out of extraction system 100. Extraction system 100 having one or more airtight fluid couplings may increase the efficiency of extracting polluted air and prevent or reduce the leaking of polluted air at junctions or connection points in extraction system 100. Alternatively, or additionally, extraction system 100 may prevent the leakage of air via a sufficient static pressure and/or volumetric flowrate provided by fan assembly 106.

In some embodiments, extraction system 100 further comprises a funnel 120 configured to expand a cross-sectional area of the flowing air to be equal with a cross-sectional area of the multistage filtration cartridge 108 prior to inputting the stream of air to multistage filtration cartridge 108. In other words, funnel 120 may be utilized to distribute the polluted air across a surface of multistage filtration cartridge 108. Funnel 120 may be shaped to match the shape of multistage filtration cartridge 108. For example, the cross-sectional shape of funnel 120 may be rectangular to match a rectangular shape of multistage filtration cartridge 108. Further, funnel 120 may expand from a first cross-sectional area to a second cross-sectional area that equals a cross-sectional area of multistage filtration cartridge 108. In some embodiments, the cross-sectional area of funnel 120 may increase linearly or nonlinearly as the cross-sectional area moves towards multistage filtration cartridge 108.

In some embodiments, funnel 120 may comprise a first side having a first cross-sectional shape and a second side having a second cross-sectional shape. Further, the first side may have a first cross-sectional shape configured to facilitate one or more connections of funnel 120 with one or more components of extraction system 100 and the second side may have a second cross-sectional shape configured to match a cross-sectional shape of the multistage filtration cartridge 108. In some embodiments, the cross-sectional shape of the funnel 120 may transition linearly or nonlinearly between the first cross-sectional shape and the second cross-sectional shape. For example, as shown in FIG. 1, funnel 120 transitions from a cross-sectional shape of a circle to a cross-sectional area of a rectangle.

In some embodiments, multistage filtration cartridge 108 may have a cross-sectional area within a range of 25 cm² to 250 cm², within a range of 50 cm² to 200 cm², within a range of 75 cm² to 150 cm², or within a range of 100 cm² to 125 cm² and a thickness of up to 200 mm, within a range of 25 mm to 150 mm, within a range of 50 mm to 100 mm, or within a range of 65 mm to 85 mm. For example, multistage filtration cartridge 108 may have a cross-sectional area of 110.25 cm² and a thickness of 79 mm. In some embodiments, multistage filtration cartridge 108 may have a width within a range of 25 mm to 300 mm, within a range of 50 mm to 250 mm, within a range of 75 mm to 200 mm, or within a range of 100 mm to 150 mm, a height within a range of 25 mm to 300 mm, within a range of 50 mm to 250 mm, within a range of 75 mm to 200 mm, or within a range of 100 mm to 150 mm, and a thickness within a range of 25 mm to 150 mm, within a range of 50 mm to 100 mm, or within a range of 65 mm to 85 mm. For example, multistage filtration cartridge 108 may have a width of 105 mm, a height of 105 mm, and a thickness of 79 mm.

Embodiments are contemplated in which multistage filtration cartridge 108 may have any width, height, thickness, and/or cross-sectional area suitable for filtering polluted air. In some embodiments, the width, height, thickness, and/or cross-sectional area of multistage filtration cartridge 108 may depend at least in part on the volume of polluted air configured to be extracted using extraction system 100. For example, if extraction system 100 is configured to extract a larger volume of polluted air, multistage filtration cartridge 108 may have a larger width, height, thickness, and/or cross-sectional area suitable to filter the larger volume of polluted air.

In some embodiments, extraction system 100 may further comprise one or more conduits 122 configured to fluidly couple fan assembly 106 to funnel 120. In some embodiments, one or more conduits 122 may be utilized to fluidly couple one or more of the components of extraction system 100 described herein. For example, one or more conduits may be utilized to connect plenum 102 to fan assembly 106. In some embodiments, the internal surface of one or more conduits 122 may be smooth to facilitate the flow of polluted air through one or more conduits 122 and prevent or reduce the collation of emissions (e.g., particulate matter) within one or more conduits 122 and/or extraction system 100.

In some embodiments, one or more conduits 122 may be coupled together using one or more corner pipe fittings. Alternatively, or additionally, one or more conduits 122 may comprise a flexible material such that one or more conduits 122 may bend at one or more locations. In some embodiments, one or more conduits 122 may be configured to prevent the venturi effect to prevent a change in velocity and prevent the creation of back pressure within one or more conduits 122. In some embodiments, the size (e.g., the inner diameter) of one or more conduits 122 may be configured to prevent or reduce the venturi effect. One or more conduits 122 may have an inner diameter within a range of 5 mm to 50 mm, within a range of 10 mm to 40 mm, or within a range of 15 mm to 30 mm. For example, one or more conduits 122 may have an inner diameter of 25 mm configured to prevent or reduce the venturi effect. Embodiments are contemplated in which any size of conduits may be utilized.

Extraction system 100 may further comprise an exhaust adaptor 124 configured to fluidly couple fan assembly 106 to one or more conduits 122. In some embodiments, exhaust adaptor 124 may reduce or prevent leakage of air between fan assembly 106 and one or more conduits 122. Further, exhaust adaptor 124 may be configured to provide an airtight connection between fan assembly 106 and one or more conduits 122. In some embodiments, a first side of exhaust adaptor 124 may have a first size and a first shape and a second side of exhaust adaptor 124 may have a second size and a second shape. For example, as depicted in FIG. 2, the shape of a first side of exhaust adaptor 124 may be rectangular and the shape of a second side of exhaust adaptor 124 may be circular.

In some embodiments, extraction system 100 may further comprise a gasket 126 positioned between funnel 120 and multistage filtration cartridge 108 to reduce or prevent the leakage of air between funnel 120 and multistage filtration cartridge 108. Further, gasket 126 may facilitate the fluid coupling and/or airtight connection between funnel 120 and multistage filtration cartridge 108. In some embodiments, gasket 126 may comprise a material configured to flex or deform to facilitate the fluid coupling between funnel 120 and multistage filtration cartridge 108, such as a foam material. For example, gasket 126 may be made of a neoprene foam material. Embodiments are contemplated in which gasket 126 may comprise any suitable material utilized to facilitate an airtight connection between one or more components.

Extraction system 100 may comprise one or more brackets or fasteners for coupling extraction system 100 to a laser printing system (e.g., laser printing system 158 as described below). In some embodiments, extraction system 100 may comprise bracket 128 and one or more fasteners 130, 132 for coupling fan assembly 106 to a device and/or system (e.g., laser printing system 158 described in more detail below). One or more fasteners 130 may be utilized to couple bracket 128 to fan assembly 106. Further, one or more fasteners 130 may be configured to reduce or prevent the vibrations of extraction system 100 from uncoupling one or more components of extraction system 100. For example, one or more fasteners 130 may be Nyloc® locking nuts configured to reduce or prevent the vibrations of extraction system 100 from uncoupling one or more components of extraction system 100.

Further, one or more fasteners 132 may be utilized to couple extraction system 100 to a laser printing system, such as a laser printing system used for printing on microscope slides. Fastener 132 may be pre-assembled washers and screws (SEMS) configured to prevent loosening of bracket 128 due to the vibrations of extraction system 100. Similarly to the Nyloc® locking nuts, SEMS may reduce or prevent the loosening of one or more fasteners 132 caused by vibrations from fan assembly 106.

In some embodiments, extraction system 100 may comprise one or more fasteners 134 for coupling the fan assembly 106 to the exhaust adaptor 124. One or more fasteners 134 may be utilized to couple bracket 128 to exhaust adaptor 124 to facilitate the coupling of exhaust adaptor 124 and fan assembly 106. In some embodiments, one or more fasteners 134 may be configured to reduce or prevent the loosening of one or more fasteners 134 caused by vibrations from fan assembly 106. For example, one or more fasteners 134 may be SEMS.

Further, one or more fasteners 136 may be utilized to couple one or more conduits 122 to one or more components of extraction system 100 disclosed herein. For example, one or more fasteners 136 may be utilized to couple one or more conduits 122 to exhaust adaptor 124. In another example, one or more fasteners 136 may be utilized to couple one or more conduits 122 and funnel 120. One or more fasteners 136 may be utilized to facilitate the fluid coupling of one or more conduits 122 to exhaust adaptor 124 and/or funnel 120. In some embodiments, one or more fasteners 136 may be configured to provide an airtight coupling of one or more conduits 122 to exhaust adaptor 124 and/or funnel 120. In some embodiments, one or more fasteners 136 may be Jubilee® clips. Embodiments are contemplated in which any suitable fastener may be utilized to facilitate the coupling of one or more components of extraction system 100 disclosed herein.

In some embodiments, extraction system 100 may further comprise one or more corner pipe fittings configured to facilitate one or more connections of one or more conduits 122. For example, extraction system 100 may further comprise a plurality of corner pipe fittings to connect a plurality of conduits 122. In embodiments comprising a plurality of conduits 122, extraction system 100 may further comprise a plurality of fasteners 136 (e.g., Jubilee® clips) configured to reduce or prevent leakage of air at each connection.

FIG. 3 depicts a top cross-sectional view of an exemplary extraction system 100 for extracting and filtering polluted air according to some embodiments. As shown in FIG. 3, polluted air 138 output from a laser printing process (e.g., a laser printing process used for printing on microscope slides) may be received by plenum 102. In some embodiments, plenum 102 may be located proximate or fit over one or more microscope slides receiving a laser printing process (described in more detail below in FIG. 4) such that the polluted air produced from the laser printing process are received by chamber 143 of plenum 102. Fan assembly 106 may provide a pressure differential that causes polluted air 138 to flow from a marking or printing area of a laser printing system, into plenum 102, and through pre-filter 104. In some embodiments, the shape of plenum 102 may comprise one or more sloped and/or curved surfaces to expand the cross-sectional area of the flowing air to allow for a larger filter (e.g., a filter with a larger cross-sectional area) to be used.

As described earlier, fan assembly 106 may provide a static pressure and/or a volumetric flowrate capable of flowing a stream of polluted air 138 through extraction system 100. Specifically, fan 107 of fan assembly 106 may provide a static pressure that is able to overcome an airflow resistance of pre-filter 104 and multistage filtration cartridge 108 such that the stream of air flows through extraction system 100. Fan assembly 106 may be disposed downstream from pre-filter 104 such that the polluted air 138 flows through pre-filter 104 prior to flowing through fan assembly 106. Flowing the stream of air containing polluted air 138 through pre-filter 104 produces a pre-filtered stream of air. In some embodiments, filtering polluted air 138 prior to flowing the air through fan assembly 106 protects one or more fans 107 of fan assembly 106 from particulate matter (e.g., a coarse size of particulate matter) that may damage one or more fans 107 and/or shorten the life expectancy of fan assembly 106. In some embodiments, one or more fans 107 of fan assembly 106 may not comprise mechanical components that are affected by the flow of particulate matter through fan assembly 106. For example, one or more fans 107 may include a bladeless fan that utilizes the Coanda effect. In such embodiments, pre-filter 104 may be omitted such that extraction system 100 does not comprise pre-filter 104.

Fan assembly 106 may be disposed upstream from multistage filtration cartridge 108 such that polluted air 138 and/or the pre-filtered stream of air flows through fan assembly 106 and then flows through multistage filtration cartridge 108 to form a stream of filtered air 140. Embodiments are contemplated in which fan assembly 106 may be disposed downstream from multistage filtration cartridge 108 comprising one or more filter stages as described herein.

Multistage filtration cartridge 108 may comprise one or more filter stages configured to filter at least a portion of the particulate matter and VOCS from polluted air 138 to form a stream of filtered air 140. For example, multistage filtration cartridge 108 may comprise a first filter stage (e.g., first filter stage 110 and/or second filter stage 112 described below) comprising one or more filters configured to filter at least a portion of the particulate matter in polluted air 138 and a second filter stage (e.g., third filter stage 114 described below) comprising one or more filters configured to filter at least a portion of the VOCS in polluted air 138. Embodiments are contemplated in which multistage filtration cartridge 108 may comprise only one filter stage configured to filter at least a portion of the particulate matter and VOCS from polluted air 138.

First filter stage 110 comprises a filter for filtering out at least a portion of the particulate matter having a first size, such as particulate matter smaller than coarse particles. First filter stage 110 may be configured to filter particles of 1 micrometer (μm) or larger in size. In some embodiments, first filter stage 110 may filter at least 25%, at least 50%, at least 60%, at least 70%, at least 75%, or at least 80% of particulate matter having a diameter of 1 μm or larger from the polluted air. First filter stage 110 may filter at least 25%, at least 50%, at least 60%, at least 70%, at least 75%, or at least 80% of PM_{2.5} from the polluted air. Further, first filter stage 110 may filter at least 90%, at least 95%, at least 99%, or at least 99.9% of PM₁₀ from the polluted air. For example, first filter stage 110 may be configured to filter 60% to 70% of PM_{2.5} and at least 90% of PM₁₀.

Second filter stage 112 comprises a filter for filtering out at least a portion of the particulate matter having a second size, such as particulate matter smaller than the particulate matter having the first size. Second filter stage 112 may be configured to filter particles of 0.1 μm or larger in size. In some embodiments, second filter stage 112 may filter at least 75%, at least 90%, at least 95%, at least 99%, at least 99.9%, at least 99.99%, or at least 99.999% of particulate matter having a diameter of 0.1 μm or larger from the polluted air. In some embodiments, second filter stage 112 may filter at least 75%, at least 90%, at least 95%, at least 99%, at least 99.9%, at least 99.99%, or at least 99.999% of particulate matter having a diameter within a range of 0.1 μm to 0.2 μm from the polluted air. For example, second filter stage 112 may filter at least 99% of particulate matter having a diameter within a range of 0.1 μm to 0.2 μm from the polluted air.

Third filter stage 114 comprises a filter for filtering out at least a portion of volatile organic compounds (VOCs) from the polluted air. Third filter stage 114 may be configured to filter volatile organic compounds (VOCs). Third filter stage 114 may be configured to filter any combination of VOCs, airborne molecular contaminations (AMCs), particulate matter, ozone, or odors. In some embodiments, third filter stage 114 may filter at least 25%, at least 50%, at least 60%, at least 70%, or at least 75% of the VOCs from the polluted air. Further, third filter stage 114 may filter at least 25%, at least 50%, at least 60%, at least 70%, or at least 75% of VOCs, airborne molecular contaminations (AMCs), particulate matter, ozone, and/or odors from the polluted air. In some embodiments, third filter stage 114 may comprise an activated carbon material configured to absorb VOCS.

The ordering of the filter stages (e.g., filter stages 110, 112, 114) may be configured to prolong the life cycle of the multistage filtration cartridge 108. For example, first filter stage 110 may be positioned upstream from second filter stage 112 and/or third filter stage 114 and filter particles of a first size (e.g., 1 μm or larger) that would otherwise quickly saturate second filter stage 112 and/or third filter stage 114. Further, second filter stage 112 may be positioned upstream from third filter stage 114 and filter particles of a second size (e.g., 0.1 μm or larger) that would otherwise quickly saturate third filter stage 114. In some embodiments, multistage filtration cartridge 108 may become saturated after filtering polluted air from 12,000 sequentially marked microscope slides having received marks from a laser printing process. Comparatively, filters used in previous techniques for extracting and filtering air become saturated after filtering polluted air from 2,000 to 3,000 sequentially marked microscope slides having received marks from a laser printing process. The extraction systems described herein provide an improvement to filter longevity compared to previous techniques for extracting and filtering polluted air.

Embodiments are contemplated in which second filter stage 112 is optionally included in multistage filtration cartridge 108. In such embodiments, multistage filtration cartridge 108 may include first filter stage 110 configured to filter at least a portion of particulate matter from the polluted air and third filter stage 114 configured to filter at least a portion of VOCS from the polluted air. Further, the ordering of the filter stages may prolong the longevity of multistage filtration cartridge 108. For example, first filter stage 110 may be disposed upstream from third filter stage 114 and prevent particulate matter from saturating third filter stage 114 to increase the longevity of third filter stage 114 and multistage filtration cartridge 108.

Embodiments are contemplated in which multistage filtration cartridge 108 may include a plurality of filter stages, such as more than three stages. For example, multistage filtration cartridge 108 may comprise three or more filters and/or stages of filtration. In some embodiments, multistage filtration cartridge 108 may comprise one or more filter stages and a housing 116 configured to couple one or more filter stages. For example, multistage filtration cartridge 108 may comprise one to seven filter stages and housing 116 configured to couple the filter stages together. Alternatively, multistage filtration cartridge 108 may be a single filter configured to filter particulate matter and VOCS from the polluted air.

In some embodiments, the one or more filter stages (e.g., first filter stage 110, second filter stage 112, and/or third filter stage 114) of multistage filtration cartridge 108 may be housed separately. Accordingly, the one or more filters of the one or more filter stages (e.g., first filter stage 110, second filter stage 112, and/or third filter stage 114) may be disposed at different positions in extraction system 100 and in fluid communication with each other. Each of first filter stage 110, second filter stage 112, and/or third filter stage 114 may be disposed upstream or downstream from fan assembly 106. For example, first filter stage 110 may be disposed upstream from fan assembly 106 such that polluted air flows through first filter stage 110 prior to flowing through fan assembly 106. In some embodiments, fan assembly 106 may be disposed downstream from any combination of filters in extraction system 100. For example, fan assembly may be disposed downstream from any combination of pre-filter 104, multistage filtration cartridge 108, first filter stage 110, second filter stage 112, or third filter stage 114. In some embodiments, at least one of the one or more filters may be disposed downstream from funnel 120 such that funnel 120 receives a stream of air and expands a cross-sectional area of the stream of air prior to inputting the stream of air to at least one of the one or more filters. For example, a filter of third filter stage 114 may be disposed downstream from funnel 120.

In some embodiments, first filter stage 110, second filter stage 112, and/or third filter stage 114 may have a cross-sectional area within a range of 25 cm² to 250 cm², within a range of 50 cm² to 200 cm², within a range of 75 cm² to 150 cm², or within a range of 100 cm² to 125 cm² and a thickness of up to 200 mm, within a range of 25 mm to 150 mm, within a range of 50 mm to 100 mm, or within a range of 65 mm to 85 mm. For example, first filter stage 110, second filter stage 112, and third filter stage 114 may each have a cross-sectional area of 110.25 cm² and a thickness of 25 mm. As used herein, depth refers to the dimension in which the air flows through the filter. For example, as depicted in FIG. 3, the depth of pre-filter 104 is the dimension in which the air flows through pre-filter 104 indicated by the arrows through pre-filter 104. Further, for example, as depicted in FIG. 3, the depth of multistage filtration cartridge 108, first filter stage 110, second filter stage 112, and/or third filter stage 114 is the dimension in which the air flows through multistage filtration cartridge 108 indicated by the arrows through multistage filtration cartridge 108.

In some embodiments, first filter stage 110, second filter stage 112, and/or third filter stage 114 may have a width within a range of 25 mm to 300 mm, within a range of 50 mm to 250 mm, within a range of 75 mm to 200 mm, or within a range of 100 mm to 150 mm, a height within a range of 25 mm to 300 mm, within a range of 50 mm to 250 mm, within a range of 75 mm to 200 mm, or within a range of 100 mm to 150 mm, and a thickness within a range of 8 mm to 50 mm, within a range of 15 mm to 35 mm, or within a range of 20 mm to 30 mm. For example, first filter stage 110, second filter stage 112, and third filter stage 114 may each have a width of 105 mm, a height of 105 mm, and a thickness of 25 mm. Embodiments are contemplated in which first filter stage 110, second filter stage 112, and/or third filter stage 114 may have differing dimensions. For example, first filter stage 110 may have a thickness of 20 mm, second filter stage 112 may have a thickness of 25 mm, and third filter stage 114 may have a thickness of 30 mm.

In some embodiments, the one or more stages of multistage filtration cartridge 108 (e.g., first filter stage 110, second filter stage 112, and/or third filter stage 114) may comprise a honeycomb shape, a pleated structure, and/or a corrugated structure configured to facilitate filtration of the emissions, such as particulate matter and/or VOCs. For example, first filter stage 110 and second filter stage 112 may comprise a pleated structure and/or a corrugated structure to facilitate the filtration of particulate matter and third filter stage 114 may comprise a honeycomb shape to facilitate the absorption of VOCs.

Polluted air 138 may originate within plenum 102 due to a laser printing process occurring within chamber 143 of plenum 102. Alternatively, fan assembly 106 may provide a static pressure and/or a volumetric flowrate to extraction system 100 such that polluted air 138 is received by chamber 143 of plenum 102. Polluted air 138 may then flow from plenum 102 through pre-filter 104 as described above to form a pre-filtered stream of air with less emissions than the stream of air input to pre-filter 104. In some embodiments, polluted air 138 and/or the pre-filtered stream of air may then flow through suction adaptor 118 configured to fluidly couple plenum 102 and/or pre-filter 104 to fan assembly 106 such that a stream of polluted air 138 flows towards fan assembly 106. As described above, fan assembly 106 may provide sufficient static pressure and/or volumetric flow rate that pulls polluted air 138 into plenum 102 and flows polluted air 138 through extraction system 100.

Polluted air 138 may flow from fan assembly 106 through exhaust adaptor 124 configured to fluidly couple fan assembly 106 and one or more conduits 122 such that polluted air 138 flows towards one or more conduits 122. One or more conduits 122 may transport polluted air 138 to funnel 120 configured to expand the cross-sectional area of the stream of air to match the cross-sectional area of multistage filtration cartridge 108 prior to inputting the stream of air into multistage filtration cartridge 108. In some embodiments, polluted air 138 may flow through first filter stage 110, second filter stage 112, and third filter stage 114 of multistage filtration cartridge 108 to form filtered air 140 from polluted air 138.

In some embodiments, extraction system 100 may be configured to remove at least 50%, at least 75%, at least 80%, at least 90%, at least 95%, or at least 99% of the emissions (e.g., particulate matter) from the polluted air. In some embodiments, extraction system 100 may be configured to reduce a concentration of the emissions and/or particulate matter in the air to 30 micrograms per cubic meter (μg/m³) or less, to 20 μg/m³ or less, to 10 μg/m³ or less, 7.5 μg/m³ or less, 5 μg/m³ or less, 2.5 μg/m³ or less, or 2 μg/m³ or less. For example, extraction system 100 may reduce a concentration of PM2.5 to 10 μg/m³ or less, 7.5 μg/m³ or less, 5 μg/m³ or less, 2.5 μg/m³ or less, or 2 μg/m³ or less.

In some embodiments, extraction system 100 may be configured to reduce the emissions (e.g., particulate matter and/or VOCS) in the polluted air by at least 50%, at least 60%, at least 70%, at least 75%, at least 80%, at least 85%, at least 90%, at least 95%, or at least 99%. For example, extraction system 100 may reduce a concentration of particulate matter in polluted air from 300 grams per cubic meter (g/m³) to 4 g/m³. In another example, extraction system 100 may reduce a concentration of PM_{2.5} in polluted air produced from consecutively laser printing on 144 microscope slides from 200 g/m³ to 4.5 g/m³. Comparatively, previous techniques for filtering air reduced the concentration of PM_{2.5} in polluted air produced from consecutively laser printing on 144 microscope slides from 200 g/m³ to 30 g/m³. In yet another example, extraction system 100 may reduce a concentration of PM_{2.5} in polluted air produced from laser printing on 50 microscope slides over a duration of an hour from approximately 64 g/m³ to 2 g/m³. Comparatively, previous techniques for filtering air reduced the concentration of PM_{2.5} in polluted air produced from laser printing on 50 microscope slides over a duration of an hour from approximately 64 g/m³ to 10 g/m³. The extraction systems described herein provide an improvement to the efficiency of filtration of emissions output from laser printing systems. In some embodiments, the extraction systems described herein provide a ten times greater reduction in particulate matter being emitted into the environment when compared to previous techniques.

Embodiments are contemplated in which extraction system 100 and/or fan assembly 106 may further comprise one or more sensors (not shown) configured to sense at least one of pollution concentration, airflow velocity, pressure, or other suitable parameters of extraction system 100. For example, extraction system 100 may comprise a sensor configured to sense a pollution concentration in the air within plenum 102 such that extraction system 100 is powered when a threshold pollution concentration is detected. In another example, extraction system 100 and/or fan assembly 106 may comprise a feedback sensor configured to cause fan assembly 106 to power on only during a laser printing process, such that extraction system 100 only extracts the emissions caused through a laser printing process and thereby extends the lifecycle of fan assembly 106, pre-filter 104, and multistage filtration cartridge 108 of extraction system 100. Alternatively, or additionally, extraction system 100 may comprise a sensor configured to sense a laser of a laser printing process such that fan assembly 106 is only powered on during the laser printing process. Further, fan assembly 106 may be configured to stay on for a specified period of time after fan assembly 106 is powered on, such that fan assembly 106 turns off after the period of time has passed to extend the lifecycle of fan assembly 106, pre-filter 104, and multistage filtration cartridge 108 of extraction system 100.

FIG. 4 depicts an isometric view of a plenum 102 according to some embodiments. Plenum 102 may comprise an opening 142, a chamber 143, one or more members 144, one or more extending surfaces 146, one or more support holders 148, and one or more openings 150. As described above, plenum 102 may be located proximate a marking or printing area of the laser printing system, such that plenum 102 receives the emissions output from a laser printing system. Further, plenum 102 may be located proximate, fit around, or otherwise contain a source of emissions (e.g., a source of particulate matter). In some embodiments, plenum 102 may be located proximate or fit around one or more microscope slides 152 during a laser printing process that creates emissions via laser 154. Further, the bottom of plenum 102 may be configured to fit around the emission source with little to no space between the emission source and the walls of plenum 102 to reduce the volume of polluted air created by the emission source. Embodiments are contemplated in which plenum 102 may be located proximate a portion of a microscope slide 152 configured to receive the laser printing process.

Opening 142 of plenum 102 may be configured to allow a laser printing process, such as a laser printing process used for printing on microscope slides, to occur within or proximate to plenum 102. Further, opening 142 of plenum 102 may be configured to allow one or more lasers 154 of a laser printing system (e.g., laser printing system 158 described below) to mark one or more microscope slides 152 proximate to or within chamber 143 of the plenum 102 such that chamber 143 of plenum 102 receives the emissions produced from the laser printing process, such as particulate matter and/or VOCS. Opening 142 may receive one or more lasers 154 from a laser printing system therethrough such that a laser printing process may occur proximate a bottom opening of or within plenum 102 and/or chamber 143.

Chamber 143 of plenum 102 may be located proximate to or fit around a printing or marking area of the laser printing system for receiving the laser printing process. Specifically, a lower portion of chamber 143 (e.g., the lower half of chamber 143) may be proximate to or fit around one or more microscope slides 152 receiving the laser printing process such that chamber 143 receives the emissions output from the laser printing system. One or more extending surfaces 146 may expand the cross-sectional area of chamber 143 such that the cross-sectional area of the airflow through chamber 143 of plenum 102 is increased as the stream of air flows towards pre-filter 104 and/or fan assembly 106. Increasing the cross-sectional area of the stream of air allows for larger (e.g., larger cross-sectional area) pre-filters to be utilized. The bottom half of plenum 102 and/or chamber 143 may be configured to receive the emissions output from the printing or marking area receiving the laser printing process such that the volume of air contaminated may be reduced. The top half of plenum 102 and/or chamber 143 may be maximized according to the available void space within a laser printing system (e.g., laser printing system 158 described below) to maximize the cross-sectional area of pre-filter 104.

One or more members 144 of plenum 102 may be configured to couple pre-filter 104 to plenum 102. As depicted in FIG. 4, plenum 102 may comprise one or more members 144 defining a holding area 145 configured to hold pre-filter 104. For example, pre-filter 104 may be at least partially disposed within holding area 145 defined by one or more members 144, such that pre-filter 104 is removably coupled to plenum 102. In some embodiments, one or more members 144 may be configured to support pre-filter 104 such that polluted air 138 flows directly from plenum 102 through pre-filter 104. One or more members may provide structural support to pre-filter 104 such that pre-filter 104 does not bend or fold when flowing air through pre-filter 104. In some embodiments, pre-filter 104 may be a separate cartridge coupled to plenum 102 or coupled to suction adaptor 118 and/or fan assembly 106. In such embodiments, plenum 102 may omit one or more members 144 and may include one or more fasteners to couple pre-filter 104 and plenum 102.

In some embodiments, the portion of plenum 102 proximal to pre-filter 104 (e.g., the top portion of plenum 102) may be larger (e.g., have a larger cross-sectional area) than the portion of plenum 102 distal to pre-filter 104 (e.g., the bottom portion of plenum 102). Plenum 102 may comprise one or more extending surfaces 146 configured to expand a cross-sectional area of plenum 102. In some embodiments, one or more extending surfaces 146 may comprise one or more slanted surfaces, one or more curved surfaces, and/or one or more L-shaped structures that expand a cross-sectional area of plenum 102. For example, as seen in FIGS. 1-4, one or more extending surfaces 146 comprises one or more slanted surfaces that expand the cross-sectional area of plenum 102 and may allow for use of filters with a larger cross-sectional area. Further, one or more extending surfaces 146 may expand the cross-sectional area of the flowing air such that the flowing air may interact with a larger cross-sectional area of a filter (e.g., pre-filter 104). Similar to funnel 120, one or more extending surfaces 146 of plenum 102 may increase the cross-sectional area of the flowing air through plenum 102 such that the cross-sectional area of the flowing air matches the cross-sectional area of pre-filter 104.

In some embodiments, the volume of plenum 102 and/or chamber 143 may depend at least in part on the volume of polluted air configured to be extracted by extraction system 100. For example, if extraction system 100 is configured to extract a larger volume of polluted air, plenum 102 and/or chamber 143 may have a larger volume suitable to contain the larger volume of polluted air. Additionally, or alternatively, the volume of plenum 102 and/or chamber 143 may depend at least in part on the size of the source of emissions, such as a printing or marking area receiving a laser printing process.

In some embodiments, plenum 102 comprises one or more support holders 148 configured to couple plenum 102 to a laser printing system, such as a laser printing system used for printing on microscope slides. For example, one or more support holders 148 may couple plenum 102 to laser printing system 158 described below. In some embodiments, one or more support holders 148 may be configured to couple to one or more rails of a laser printing system (e.g., laser printing system 158 described below in FIG. 5) such that plenum 102 may transition to any position along the rails. One or more support holders 148 may comprise ball spring plungers configured to allow for quick removal of plenum 102 from the one or more rails. In some embodiments, plenum 102 may be constrained in 5 degrees of freedom such that the only movement of plenum 102 allowed is the removal from the one or more rails.

In some embodiments, plenum 102 may further comprise one or more openings 150 configured to allow one or more sensors (e.g., one or more sensors of a laser printing process or one or more sensors of extraction system 100) to gather data while utilizing extraction system 100 and/or plenum 102. For example, plenum 102 may comprise an opening 150 that allows one or more sensors to gather data from within chamber 143 of plenum 102.

In some embodiments, laser 154 of a laser printing system and/or process may be utilized to mark and/or etch a surface layer (e.g., an ink tab) on one or more microscope slides 152 or the surface of one or more microscope slides 152. Laser 154 may be utilized to form marks 156 on one or more microscope slides 152. Producing marks 156 on one or more microscope slides 152 may produce emissions (e.g., particulate matter) as described herein. Embodiments are contemplated in which marks 156 may be created directly on one or more microscope slides 152. Alternatively, or additionally, marks 156 may be created on a tab, a layer of ink, or a similar layer disposed on one or more microscope slides 152. The portion of one or more microscope slides 152 receiving the laser printing process may be the source of emissions as described herein. Exemplary embodiments of laser printing systems and methods are described below in FIG. 5.

FIG. 5 depicts an exemplary laser printing system 158 and extraction system 100. In some embodiments, laser printing system 158 comprises extraction system 100. Alternatively, or additionally, extraction system 100 may be separate from or removably couplable to laser printing system 158. In some embodiments, extraction system 100 may be mounted in laser printing system 158. In some embodiments, the laser printing systems or processes described herein may be similar to those found in commonly owned U.S. application Ser. No. 18/543,535, titled “LABELING TECHNIQUE USING LASER-MARKABLE INK” or commonly owned PCT Application Serial No. PCT/IT2023/000038, titled “REVERSE MARKING OF MICROSCOPE SLIDES” the entireties of which are incorporated by reference herein. In some embodiments, extraction system 100 may be coupled to laser printing system 158 via bracket 128 and one or more fasteners 132 as described above.

In some embodiments, laser printing system 158 comprises one or more rails 160 configured to operate a drawer 162. One or more rails 160 may be configured to transition drawer 162 between an open position and a closed configuration. In some embodiments, plenum 102 may be coupled to drawer 162 such that plenum 102 moves with drawer 162 when moving along one or more rails 160. Alternatively, or additionally, plenum 102 may be coupled to one or more rails 160 via one or more support holders 148 such that plenum 102 may move along one or more rails 160. In some embodiments, as described above, plenum 102 may be coupled using one or more support holders 148 to one or more rails 160 such that plenum 102 may be constrained in 5 degrees of freedom with respect to one or more rails 160. For example, plenum 102 may be constrained such that plenum 102 may only move in one direction that uncouples plenum 102 from one or more rails 160.

Plenum 102 may uncouple from suction adaptor 118 and/or fan assembly 106 when drawer 162 is in an open position and may couple to suction adaptor 118 and/or fan assembly 106 when drawer 162 is in the closed position. In some embodiments, plenum 102 may be coupled to suction adaptor 118 and/or fan assembly 106 using one or more snap fit fasteners or other suitable fasteners. Alternatively, plenum 102 may be moved proximate suction adaptor 118 and/or fan assembly 106 such that the polluted air flows from plenum 102 to fan assembly 106 without coupling plenum 102 to suction adaptor 118 and/or fan assembly 106.

In some embodiments, at least a portion of extraction system 100 may be stationary within laser printing system 158. For example, fan assembly 106, one or more conduits 122, funnel 120, and/or at least a portion of multistage filtration cartridge 108 may be stationary within laser printing system 158. Additionally, or alternatively, at least a portion of extraction system 100 may be movable within laser printing system 158. For example, plenum 102 may be movable within laser printing system 158 as described above. Further, for example, pre-filter 104 and/or at least a portion of multistage filtration cartridge 108 may be movable within laser printing system 158 such that pre-filter 104 and/or multistage filtration cartridge 108 may be replaced.

Embodiments are contemplated in which pre-filter 104 and/or multistage filtration cartridge 108 may be removed, cleaned, and returned to extraction system 100. Further, pre-filter 104 and/or multistage filtration cartridge 108 may be removably couplable to laser printing system 158 such that pre-filter 104 and/or multistage filtration cartridge 108 may be easily removed and cleaned and/or replaced. For example, pre-filter 104 may be removably couplable within drawer 162 of laser printing system 158, such that pre-filter 104 may be easily accessed when drawer 162 is opened. In another example, multistage filtration cartridge 108 may be removably couplable to an outside surface of laser printing system 158, such that multistage filtration cartridge 108 may be easily accessed to remove and clean and/or replace multistage filtration cartridge 108.

In some embodiments, laser printing system 158 may be configured for histopathology purposes, such as marking one or more microscope slides 152. Laser printing system 158 may further comprise one or more baskets 164 configured to hold one or more microscope slides 152. In some embodiments, one or more baskets 164 may feed microscope slides 152 into the laser printing system 158 to mark each microscope slide 152 individually. For example, one or more baskets 164 may deliver one or more microscope slides 152 to a marking or printing area such that the microscope slides 152 may be marked using the laser printing system 158.

Although microscopes slides are used as an exemplary embodiment, embodiments are contemplated in which any of microscope slides, cassettes, or any other sample holders may be utilized. Laser printing system 158 may be configured to mark any combination of sample holders as described above. One or more baskets 164 may be configured to hold any sample holders as described above. For example, laser printing system 158 may comprise a first basket configured to hold a plurality of microscope slides and a second basket configured to hold a plurality of cassettes. Further, laser printing system 158 may utilize the first basket and the second basket to mark both microscope slides and cassettes.

In some embodiments, laser printing system 158 comprises a display 166. Further, display 166 may act as a user interface configured to allow a user to control laser printing system 158. For example, display 166 may be a touch screen configured to respond to a user's touch, such as from a user's finger. Alternatively, or additionally, laser printing system 158 may comprise a separate display 166 and user interface such that one or more actions may be controlled via one or more buttons, switches, dials, or other suitable controls. In some embodiments, laser printing system 158 may comprise a power button 168 configured to toggle on/off power to the laser printing system 158 and a display 166 with a touch screen allowing the user to control laser printing system 158 therefrom.

In some embodiments, after one or more microscope slides 152 have been marked by the laser printing system 158, the marked slides may be expelled from the laser printing system 158 into one or more holders 170. One or more holders 170 may hold a plurality of microscope slides 152 having received markings from the laser printing system 158. Embodiments are contemplated in which one or more holders 170 may be configured to hold any combination of microscope slides, cassettes, or other suitable sample holders.

FIG. 6 depicts an exemplary method 600 of extracting and filtering polluted air using a system for extracting and filtering polluted air as described herein. At step 602, polluted air may be extracted using an extraction system, such as extraction system 100 described above. More specifically, a fan assembly (e.g., fan assembly 106) may extract the polluted air. In some embodiments, the fan assembly may be configured to provide a static pressure and/or a volumetric flowrate that is sufficient to flow the polluted air through the extraction system. For example, the fan assembly may provide a static pressure within a range of 100 Pa to 400 Pa such that the polluted air flows through the extraction system.

In some embodiments, as described above, extraction system 100 and/or fan assembly 106 may comprise one or more sensors such that fan assembly 106 extracts polluted air in response to any of extraction system 100 turning on, reaching a threshold concentration of emissions, or sensing a laser of a laser marking process. For example, fan assembly 106 may comprise a feedback sensor configured to cause fan assembly 106 to power on (i.e., provide a pressure differential to extraction system 100) in response to a laser printing system powering on, such that extraction system 100 only extracts the emissions produced by a laser printing process and thereby extends the lifecycle of fan assembly 106, pre-filter 104, and multistage filtration cartridge 108 of extraction system 100. In another example, fan assembly 106 may extract the polluted air in response to marking one or more microscope slides 152.

Step 602 may comprise receiving emissions output from a laser printing process (e.g., a laser printing process for marking microscope slides) via plenum 102 of extraction system 100 as described herein. Fan assembly 106 may provide a static pressure and/or a volumetric flowrate to draw the emissions output from the laser printing process into chamber 143 of plenum 102 such that plenum 102 receives the output emissions.

In some embodiments, step 602 may comprise containing polluted air comprising the emissions in plenum 102 of extraction system 100. Fan assembly 106 may provide a static pressure and/or a volumetric flowrate that reduces or prevents polluted air from escaping plenum 102. For example, fan assembly 106 may provide a static pressure such that the polluted air is contained within plenum prior to flowing the polluted air through one or more filters (e.g., pre-filter 104 and/or multistage filtration cartridge 108).

At step 604, polluted air may be filtered using a pre-filter (e.g., pre-filter 104). Flowing the polluted air using the pre-filter may filter at least a portion of particulate matter having a coarse size (e.g., a diameter of 10 μm or larger) as described above. Embodiments are contemplated in which step 604 may be optional. For example, step 604 may be omitted such that polluted air is not filtered using a pre-filter.

At step 606, polluted air may be filtered using a multistage filtration cartridge, such as multistage filtration cartridge 108 described above. The multistage filtration cartridge may comprise one or more filter stages (e.g., first filter stage 110, second filter stage 112, and/or third filter stage 114). In some embodiments, the multistage filtration cartridge may further comprise additional filter stages. For example, the multistage filtration cartridge may comprise three or more, four or more, five or more, or six or more filter stages. At step 606, flowing the polluted air through the multistage filtration cartridge filters at least a portion of particulate matter and at least a portion of the VOCS to form a filtered stream of air. Further, at least a portion of particulate matter having a first size smaller than the coarse size (e.g., a diameter of 1 μm or larger), at least a portion of particulate matter having a second size smaller than the first size (e.g., a diameter of 0.1 μm or larger), and/or at least a portion of VOCS may be removed from the polluted air to form a filtered air.

At step 608, the filtered air is expelled from the extraction system, such as extraction system 100. The filtered air may be expelled from the multistage filtration cartridge and into the environment. More specifically, the filtered air may be expelled after the polluted air has been filtered by each filter stage of the multistage filtration cartridge.

Embodiments are contemplated in which method 600 further comprises containing a source of polluted air within plenum 102. The source of the polluted air may be contained prior to extracting the polluted air in step 602. For example, plenum 102 may be positioned within laser printing system 158 such that plenum 102 contains the source of the polluted air (e.g., a printing or marking area of a laser printing system).

Embodiments are contemplated in which method 600 further comprises marking one or more microscope slides via a laser printing process. In some embodiments, marking one or more microscope slides (e.g., one or more microscope slides 152) creates emissions, such as particulate matter and VOCs. Further, the point at which a laser (e.g., laser 154) from the laser printing process contacts a surface of a microscope slide may be the source of the polluted air.

Although the present disclosure has been described with reference to the embodiments illustrated in the attached drawing figures, it is noted that equivalents may be employed, and substitutions made herein without departing from the scope of the present disclosure as recited in the claims.

Having thus described various embodiments of the present disclosure, what is claimed as new and desired to be protected by Letters Patent includes the following:

1. A system for mounting in a laser printing system and for extracting and filtering polluted air output during a laser printing process for marking microscope slides, the system comprising:
a plenum comprising a chamber for receipt of the polluted air output from the laser printing system;
a pre-filter in fluid communication with the plenum,
wherein the pre-filter receives a stream of air therethrough comprising the polluted air contained in the plenum,
wherein a flow of the stream of air through the pre-filter filters out particulate matter having a coarse size to produce a pre-filtered stream of air;
one or more filters in fluid communication with the pre-filter,
wherein the one or more filters receive the pre-filtered stream of air from the pre-filter,
wherein the one or more filters comprises:
a first filter to filter at least a portion of the particulate matter having a first size,
wherein the first size of the particulate matter is less than the coarse size of the particulate matter filtered by the pre-filter; and
a second filter to filter at least a portion of volatile organic compounds; and
a fan assembly comprising at least a fan for providing a pressure differential to the system to cause flow of the stream of air from the plenum, through the pre-filter, through the fan assembly, and through the one or more filters.

2. The system of claim 1,
wherein the plenum comprises one or more members defining a holding area,
wherein the pre-filter is at least partially disposed within the holding area.

3. The system of claim 2, wherein the plenum further comprises one or more support holders removably couplable to the laser printing system.

4. The system of claim 1,
wherein the fan assembly is disposed downstream from the pre-filter and disposed upstream from the one or more filters,
wherein the one or more filters further comprises a third filter to filter at least a portion of the particulate matter having a second size,
wherein the second size of the particulate matter is less than the first size of the particulate matter filtered by the first filter,
wherein the third filter is disposed downstream from the first filter and disposed upstream from the second filter.

5. The system of claim 1, further comprising:
a multistage filtration cartridge comprising the one or more filters; and
a funnel in fluid communication with the pre-filter and the multistage filtration cartridge,
wherein the funnel receives the pre-filtered stream of air therethrough,
wherein the multistage filtration cartridge receives the pre-filtered stream of air from the funnel,
wherein the multistage filtration cartridge is in fluid downstream communication with the funnel, such that the pre-filtered stream of air outputted from the funnel is input to the multistage filtration cartridge to expand a cross-sectional area of the pre-filtered stream of air prior to inputting the pre-filtered stream of air to the multistage filtration cartridge.

6. The system of claim 1,
wherein the plenum further comprises an opening for receiving a laser of the laser printing system,
wherein the laser extends through the chamber of the plenum and towards a printing area of the laser printing system.

7. The system of claim 1, wherein the plenum further comprises:
a first cross-sectional area;
a second cross-sectional area that is greater than the first cross-sectional area; and
one or more extending surfaces that transitions the first cross-sectional area of the plenum to the second cross-sectional area of the plenum.

8. A system for mounting in a laser printing system and for extracting and filtering polluted air output during a laser printing process for marking microscope slides, the system comprising:
a plenum comprising a chamber for receipt of the polluted air output from the laser printing system;
one or more filters in fluid communication with the plenum,
wherein the one or more filters receives a stream of air therethrough comprising the polluted air contained in the plenum,
wherein the one or more filters filter at least a portion of particulate matter and at least a portion of volatile organic compounds; and
a fan assembly for providing a pressure differential to the system to cause flow of the stream of air from the plenum and through the one or more filters.

9. The system of claim 8, wherein the fan assembly comprises a bladeless fan.

10. The system of claim 8, wherein the plenum comprises an opening for receiving a laser from the laser printing system such that the laser extends through the chamber of the plenum and marks one or more microscope slides in a marking area of the laser printing system.

11. The system of claim 8,
wherein the one or more filters comprises a first filter for filtering at least a portion of the particulate matter having a first size,
wherein the one or more filters further comprises a second filter for filtering at least a portion of the particulate matter having a second size,
wherein the second size of the particulate matter is less than the first size of the particulate matter filtered by the first filter,
wherein the one or more filters further comprises a third filter for filtering at least a portion of the volatile organic compounds,
wherein the third filter is disposed downstream from the first filter and the second filter.

12. The system of claim 11, further comprising:
a multistage filtration cartridge comprising the one or more filters,
wherein the fan assembly is disposed downstream from the plenum and disposed upstream from the multistage filtration cartridge.

13. The system of claim 12, further comprising a suction adaptor that fluidly couples the plenum to the fan assembly.

14. The system of claim 8, further comprising:
a funnel disposed upstream from at least one of the one or more filters,
wherein the funnel receives the stream of air and expands a cross-sectional area of the stream of air prior to inputting the stream of air to at least one of the one or more filters.

15. A method for extracting and filtering emissions from a laser printing process for marking microscope slides via an extraction system, the method comprising:
receiving emissions output from the laser printing process via a plenum of the extraction system;
containing polluted air comprising the emissions in the plenum of the extraction system,
wherein the extraction system further comprises a fan assembly and one or more filters;
extracting, by flowing via the fan assembly, the polluted air from the plenum to form a stream of air comprising the polluted air; and
flowing the stream of air through the one or more filters to filter at least a portion of particulate matter and at least a portion of volatile organic compounds to form a filtered stream of air.

16. The method of claim 15,
wherein the extraction system further comprises a pre-filter,
wherein the method further comprises flowing the polluted air through the pre-filter to filter at least a portion of the particulate matter having a coarse size prior to flowing the polluted air through the one or more filters.

17. The method of claim 16,
wherein the plenum comprises:
a first cross-sectional area;
a second cross-sectional area that is greater than the first cross-sectional area; and
one or more extending surfaces that transitions the first cross-sectional area of the plenum to the second cross-sectional area of the plenum,
wherein the method further comprises expanding a cross-sectional area of the stream of air via the one or more extending surfaces to distribute the stream of air across a surface of the pre-filter.

18. The method of claim 15,
wherein the extraction system further comprises a multistage filtration cartridge comprising a first filter stage having a first filter of the one or more filters, a second filter stage having a second filter of the one or more filters, and a third filter stage having a third filter of the one or more filters,
wherein flowing the stream of air through the one or more filters comprises:
flowing the stream of air through the first filter stage to filter at least a portion of the particulate matter having a first size;
flowing the stream of air through the second filter stage to filter at least a portion of the particulate matter having a second size smaller than the first size; and
flowing the stream of air through the third filter stage to filter at least a portion of the volatile organic compounds.

19. The method of claim 15, further comprising:
marking one or more microscope slides via a laser,
wherein the laser extends through an opening of the plenum,
wherein extracting the polluted air is in response to marking the one or more microscope slides.

20. The method of claim 18,
wherein the extraction system further comprises a funnel directly fluidly coupled to at least one of the one or more filters,
wherein the method further comprises expanding a cross-sectional area of the stream of air via the funnel to distribute the stream of air across a surface of at least one of the one or more filters.
